(19) United States
(12) Patent Application Publication
(10) Pub. No.: US 2010/0176186 A1
(43) Pub. Date: Jul. 15, 2010

(54) Alternative Substrate Envelope Sealing And Closure System

(76) Inventor: David J. Law, Brooksville, FL (US)

Correspondence Address: ST. ONGE STEWARD JOHNSTON & REENS, LLC, 986 BEDFORD STREET, STAMFORD, CT, 06905-5619, US

(21) Appl. No.: 12/352,852

(22) Filed: Jan. 13, 2009

(51) Int. Cl. B65D 27/04; B65D 27/14; B31B 19/00; B31B 19/90; B31B 19/74

(52) U.S. Cl. 229/80; 493/919; 156/227

(57) ABSTRACT

An alternative substrate envelope sealing and closure system apparatus and method for same, whereby the system comprises an envelope having a segment of its back panel cut-out and replaced with a material that is more adhereable than the material of the outer surface of the envelope. The envelope lacks hot melt adhesives or peel and seal type latex adhesives. A method for sealing alternative substrate envelopes in mass quantities, whereby alternative substrate envelopes are utilized at high speeds for commercial use and insertion. A method for the large scale packing and sealing of alternative substrate envelopes, whereby the envelopes are packed and sealed using automated devices.

### FIELD OF THE INVENTION

The present invention relates to an envelope sealing and closure system apparatus and method, whereby the system comprises an envelope having a segment of its back panel cut-out and replaced with a material that is more adhereable than the material of the outer surface of the envelope. The present invention also relates to a method for manufacturing the envelope sealing and closure system as well as a method for sealing envelopes in mass quantities using automated devices.

### BACKGROUND OF THE INVENTION

Throughout the years, envelopes have been used to transport letters and other materials, while protecting the contents inside the envelopes. Conventional envelopes are typically made from paper or other such adhereable materials that allow for easy sealing of envelopes. In a conventional envelope, the top flap of the envelope folds down and seals to the body of the envelope, typically the back of the envelope. This causes the envelope to seal, which allows the contents inside the envelope to be transported and protected during transport.

As envelopes became more sophisticated, various other designs have been implemented to seal envelopes and to protect the contents inside the envelopes. U.S. Pat. No. 2,066,495 teaches an envelope with a seal flap that has an adhesive strip, as well as having the back panel of the envelope contain a number of spaced apertures. The adhesive strip on the seal flap adheres to the adhesive strip on the back of the envelope through the spaced apertures, thus sealing the envelope. U.S. Pat. No. 1,974,339 teaches an envelope with an adhereable material overlaid on the back of the envelope. The seal flap is folded down and adheres to the back of the envelope to thus seal the envelope. These designs were done to improve sealing as well as to see if the seal has been tampered with during transport.

Many envelope sealing designs work well to seal envelopes made of standard materials. However, industry has shifted to the production of envelopes made from materials that are stiffer and more sturdy than standard envelope materials. Envelopes can now be made of alternative substrates such as polypropylenes and mylar derivates. These alternative substrates function to protect the contents of an envelope from water and dirt. This prevents the contents inside the envelopes from becoming damaged or folded, as alternative substrates are typically stiffer than paper substrates, and the alternative substrates do not allow dirt, water, or other materials to flow into the envelopes.

Despite these advantages, a major problem for alternative substrate envelopes is that these envelopes cannot be adequately sealed. Furthermore, conventional envelope manufacturing equipment is limited in scope of its ability to utilize alternative substrate type materials at high speeds for commercial use and insertion.

What is desired therefore is a design that allows for sealing of envelopes made from alternative substrates. A design is necessary that can seal these envelopes without the use of any hot melt adhesives or peel and seal type latex adhesives.

Furthermore, a method is desired for large scale production of alternative substrate envelopes that allow for these multiple alternative substrates to be produced conventionally. Also desired, is a method for the large scale packing and sealing of alternative substrate envelopes, whereby the envelopes are packed and sealed using automated devices.

### SUMMARY OF THE INVENTION

Accordingly, it is an object of the present invention to provide an envelope made from an alternative substrate that can be sealed without the use of any hot melt adhesives or peel and seal type latex adhesives. It is also an object of the present invention to provide a method for the large scale production of alternative substrate envelopes that allow for these envelopes to be produced conventionally; similar to typical paper envelopes. It is a further object of the present invention to provide a method for the large scale packing and sealing of alternative substrate envelopes, whereby the envelopes are packed and sealed using automated devices.

These and other objectives are achieved by providing an envelope comprising: an outer surface made of a first material, and an inner surface made of a second material whereby the envelope comprises a back panel that has segment cut out of it and patched with a third material. An envelope flap then folds to bond with this third material, wherein the third material is more adhereable than the first material of the outer surface of the envelope.

To seal the envelope, the flap, which typically is located at the top of the envelope, has a sealing section that is aligned with the third material on the back panel of the envelope. The flap is folded down and the sealing section forms a bond with the third material. The bond of the flap with the third material on the back panel of the envelope is typically an adhesive bond and seals the envelope.

The envelope flap can be elongated vertically and/or horizontally and allows the sealing section of the flap to correspond with the third material on the back panel of the envelope.

The invention further comprises attaching an adhesive strip on the flap that folds down. This adhesive strip bonds with the third material on the back panel of the envelope to seal the envelope.

Another embodiment of the invention comprises locating an adhesive strip on the third material on the back panel, instead of on the sealing flap. The adhesive strip bonds to the inside section of the envelope made of the second material. This material is typically a standard material, such as a paper substrate or a material with high adhereability properties.

In certain embodiments of the invention, the third material is the same as the second material located on the inside the envelope. Typically, this material can be paper or another conventional material that has high adhereability.

A further embodiment of the invention involves the flap containing both a sealing and non-sealing section. The sealing section corresponds with the third material on said back panel when the envelope is sealed. The non-sealing section can be made of the first material, which has less adhereability than both the second and third material. The non-sealing section may also be made of another material whereby the non-sealing section is made up of a material that has less adhereability than the sealing section.

In a preferred embodiment, the present invention also includes a window on the front of the envelope. The window can be cut-out using a die or other such cutting device, and is typically patched with a transparent material. This transparent material allows the contents inside the envelope to be displayed and would allow for an address located on a letter to be shown during transport.

The invention further does not require the use of any hot melt adhesives or peel and seal type latex adhesives. These types of materials are typical of previous designs for envelopes made of alternative substrates.

In another preferred embodiment of the invention, the outer surface of the invention can be made of a non-adhereable material. This non-adhereable invention can be slippery and can resist adhesion. The present invention allows envelopes to be sealed even though the envelopes contain an outer surface made of a non-adhereable material.

In another preferred embodiment, the third material located on the back panel of the envelope is more adhereable than the first material of the outer surface of the envelope by a factor of two or greater. In another preferred embodiment, the third material is more adhereable than the first material of the outer surface of the envelope by a factor of ten or greater.

Another embodiment of the invention further comprises a right flap, a left flap, and a bottom flap, wherein the right flap and left flap bond to the bottom flap to form the back panel of the envelope.

Other objects of the present invention are achieved by a method of manufacturing an envelope. The method comprises the steps of introducing an envelope with an outer surface made of a first material, removing a segment from the back of the envelope, patching said segment with a second material, wherein said second material is more adhereable than said first material, and aligning the second material with a flap to allow for the sealing of the envelope.

In one embodiment, the method further comprises applying an adhesive strip on said flap. In another embodiment, the method further comprises applying an adhesive strip on the second material on the back of the envelope. This adhesive strip helps seal the envelope.

In a preferred embodiment, the outer surface of the envelope is made of a non-adhereable material or a material with very low adhereability. This material is typically a material such as a polypropylene or mylar derivative. Other materials could be various light metals, plastics, or other such materials that have low adhereability properties.

Furthermore, the invention comprises cutting out a window on the front panel of the envelope. A further step involves simultaneously cutting the window and the back of the envelope. This can be done via a die or other instrument that cuts holes. This step allows time to be saved whereby both holes are cut in one pass through a die cutting machine, for manufacturing the envelopes.

The method further involves the step of patching the window with a transparent material, so that the contents inside the envelope can be viewed.

Another aspect of the present invention involves a method of sealing an alternative substrate envelope, comprising the steps of introducing an envelope with an outer surface of a first material, and inner surface of a second material, wherein the envelope has a removed segment from the back of the envelope patched with a third material; packing various contents such as a letter into the envelope; folding a top flap of the envelope down, wherein the top flap has the second material on its inner surface; and sealing the envelope, wherein the second material bonds with the third material patched on the back of the envelope, wherein the third material is more adhereable than the first material.

A preferred embodiment of this invention involves the first material being non-adhereable.

Furthermore, the method comprises automated devices which pack the contents such as a letter into the envelope. The method further has the automated devices conduct the step of folding and sealing the envelope. This step allows for the large scale packaging of envelopes, thus removing the human aspect, whereby a person would be required to pack and seal the envelopes. This method also allows for mass quantities of alternative substrate envelopes to be packed and sealed, saving on costs and time of human labor.

Other objects of the invention and its particular features and advantages will become more apparent from consideration of the following drawings and accompanying detailed description

### BRIEF DESCRIPTION OF THE DRAWINGS

FIG. 1 is a front isometric view of the envelope according to an exemplary embodiment of the present invention.

FIG. 2 is an exploded view of the envelope shown in FIG. 1 where the envelope contains a cut out portion in its back panel.

FIG. 3 is an exploded view of the envelope shown in FIG. 2 where the cut out portion in the back panel is patched with an adhereable material.

FIG. 4 is an isometric view of the envelope shown in FIG. 3 where the envelope pouch is shown in a closed position

FIG. 5 is an isometric view of the envelope when it is sealed.

FIG. 6 is cross-section view of the envelope of FIG. 5, in accordance with the present invention

### DETAILED DESCRIPTION OF THE INVENTION

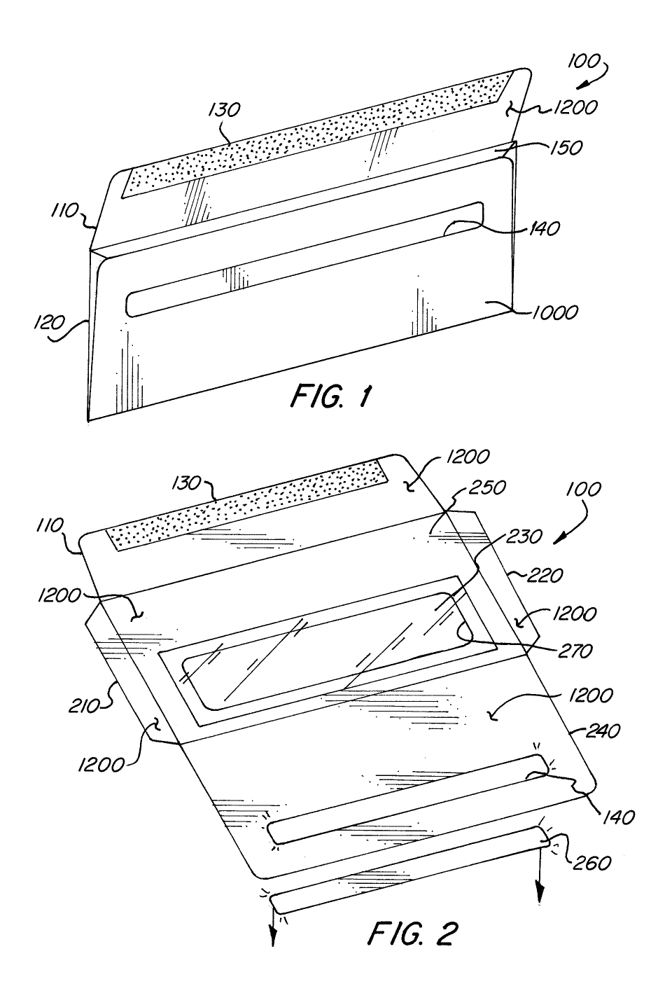

FIG. 1 is a front isometric view of the envelope 100 according to an exemplary embodiment of the present invention. Shown is top flap 110 which contains adhesive strip 130. This adhesive strip 130 can be made of various materials which cause adhesion to various surfaces. These materials include various sticky materials that when wet can cause adhesion, such as an adhesive strip of a standard envelope.

Envelope body 120 is shown containing a cut-out section 140. The cut-out section 140 can be cut out using a die or any such cutting device. Envelope inside space 150 is shown whereby contents, such as letters, can be placed in the envelope body 120. This is used to provide functionality to envelope 100.

FIG. 1 also shows an outer surface 1000 of the envelope 100. This outer surface 1000 is typically made of a first material 1001. The first material 1001 can be made of alternative substrates such as polypropylenes and mylar derivates. Other substrates can be used such as light metals, plastics, and other such materials. These materials tend to have low adhereability properties. These alternative substrates also function to make an envelope more study to protect the contents of the envelopes from water and dirt. In various embodiments, this first material 1001 can be a non-adhereable material, or material that has extremely low adhereability properties.

In FIG. 1, the inner surface 1200 of the envelope is also shown as the inner surface of top flap 110. The inner surface 1200 is made of a second material 1201. This second material 1201 is made of an adhereable material such as paper, or another generally adhereable material. The second material can also have sections made of an alternative substrate such as mylar or polypropylenes. In a preferred embodiment, the second material 1201 is a material with high adhereability properties.

FIG. 2 of the present invention shows an exploded view of the envelope 100 shown in FIG. 1. In FIG. 2, the top flap 110 is shown with adhesive strip 130. The front panel 250 of the envelope is shown as well as the left flap 210 and right flap 220. The front panel 250 contains a window 230 covered by a transparent layer 270. The transparent layer 270 is shown on the inside of the window 230. The transparent layer is used to allow the contents inside the envelope 100 to be viewed.

FIG. 2 also shows a bottom flap 240 that contains cut-out section 140. Removed piece 260, which corresponds to cut-out section 140, is shown below having been removed by a die cutter or other such device.

Inner surface 1200 is also shown in FIG. 2, whereby the inner surface 1200 is shown on top flap 110, front panel 250, left flap 210, right flap 220, and bottom flap 240. This inner surface 1200 is typically made of an adhereable material such as paper.

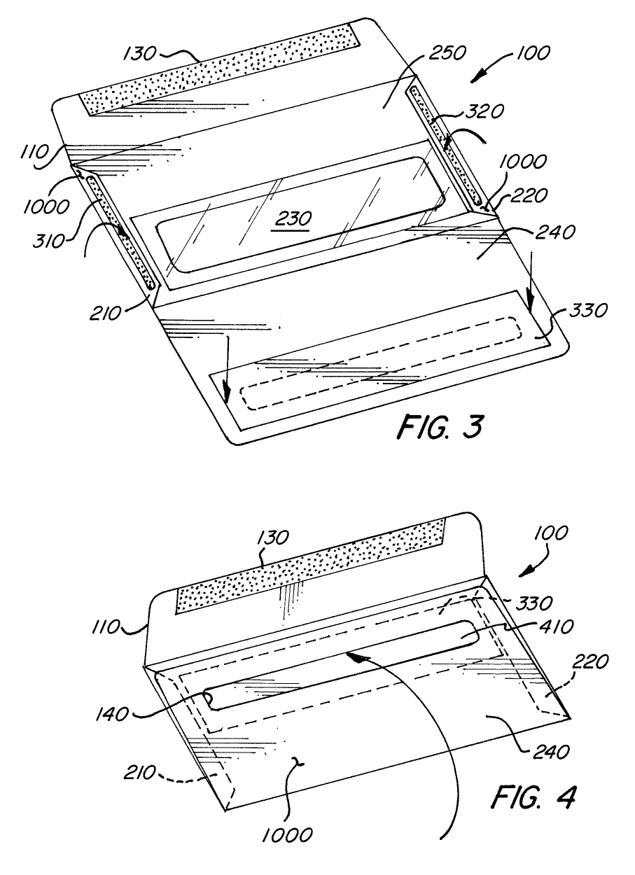

FIG. 3 shows an exploded view of the envelope 100 shown in FIG. 2 where the cut-out section 140 of the bottom flap 240 is patched with a third material 330. This third material 330 is shown patched on the inside of the cut-out section 140 of envelope 100. Also shown in FIG. 3 are left flap 210 and right flap 220 being folded over. These flaps contain outer surface 1000 on the outside of the flaps. These flaps are used to form the back of the envelope with bottom flap 240.

FIG. 4 shows bottom flap 240 folded upwards to form the back of the envelope 100. Bottom flap 240 is shown sitting on left flap 210 and right flap 210 to form the back panel of the envelope 100. Third material 330 is shown underneath bottom flap 240. However, a section 410 of third material 330 is shown and can be accessed. This section 410 of third material 330 is more adhereable than the first material 1001 of the outer surface 1000 of the envelope 100.

FIG. 4 further shows how adhesive strip 130 is aligned with section 410 of third material 330. This adhesive strip 130 can adhere to section 410, thus sealing the envelope. The section 410 of the third material 330 is more adhereable than the first material 1001 on said outer surface 1000 of the envelope 100. It is the ability of section 410 of third material 330 to adhere to the adhesive strip 130 on top flap 110, which allows the envelope 100 to seal.

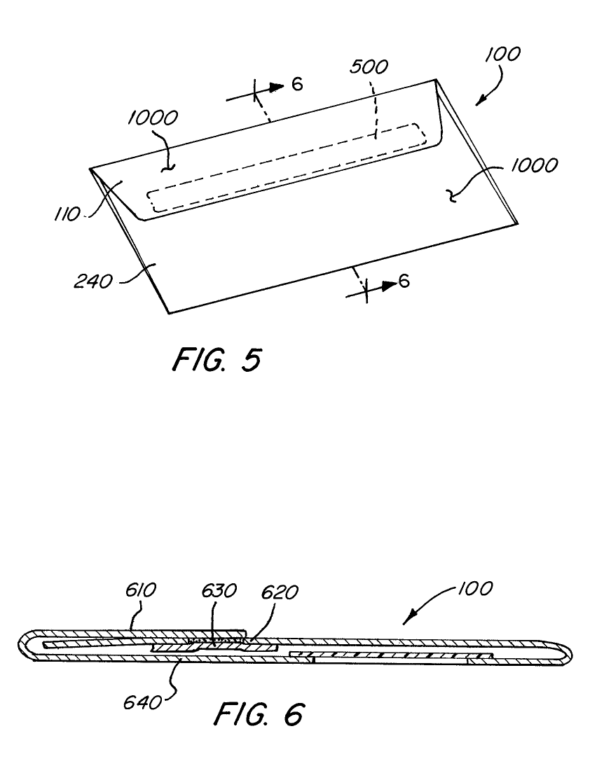

The sealed envelope 100 is shown in FIG. 5. Here, top flap 110 is shown folded down and bonded with the bottom flap 240. Section 500 shows the bond of section 410 of third material 330 with the adhesive strip 130 on top flap 110. Another embodiment of the invention can be shown whereby adhesive strip 130 can be present on section 410 of the third material 330. While this embodiment is not shown, the envelope 100 will seal in the same manner as in the present embodiment.

Furthermore, outer surface 1000 is shown on top flap 110 and bottom flap 240. This shows that the outer surface 1000 is present throughout the entire outer surface 1000 of the envelope 100. This protects envelope 100 and its contents (not shown) from water and other materials. The outer surface 1000 of the envelope 100 is made of an alternative substrate. This outer surface 1000 typically has low adhereability.

FIG. 6 is a cross-sectional view of envelope 100, when envelope 100 is sealed. In FIG. 6, top flap 610 is shown sealed to bottom flap 620. The third material 630 is shown underneath the bottom flap 620. The third material 630 is responsible for binding with top flap 610 to seal the envelope.

Also shown in FIG. 6 is the front panel 640 of envelope 100. Front panel 640 can contain a window (not shown). This window is used to display the contents of envelope 100.

Another embodiment of the invention involves the envelope not requiring the use of any hot melt adhesives or peel and seal type latex adhesives. This is important as it can save costs for adhesives as well as the time to add the adhesives to the envelopes.

A further embodiment of the invention involves the third material 330 being more adhereable than the first material 1001 of the outer surface 1000 by a factor of two or greater. In a preferred embodiment, third material 330 is more adhereable than the first material 1001 of the outer surface 1000 by a factor of ten or greater.

Other embodiments involve the second material of the inner surface 1200 of the envelope 100 being the same material as the third material 330. Typically both the second and third materials can be a standard substrate such as paper.

Another embodiment of the present invention involves the first material 1001 on the outer surface 1000 of the envelope being non-adhereable, or having very low adhereability properties.

Another object of the present invention involves a method for manufacturing an envelope. This embodiment comprises the steps of introducing an envelope 100 with an outer surface 1000 made of a first material 1001; removing a segment 140 from the back 240 of the envelope 100; patching the segment 140 with a second material 330 wherein said second material 330 is more adhereable than said first material 1001; and aligning the second material 330 with a flap 110 to allow for the sealing of envelope 100. The method further can comprise the step of applying an adhesive strip 130 on the flap 110.

In an alternative embodiment, the step of applying an adhesive strip 130 is on the second material 330 on the back of the envelope 100.

In a preferred embodiment, the outer surface 1000 of the envelope 100 is made of a non-adhereable material or a material with low adhereability. Furthermore, the method can comprise the step of cutting out a window 230 on the front of the envelope 100. The method further comprises patching the window 230 with a transparent material 270.

The method further comprises the step of cutting the window 230 and the segment 140 in the back 240 of the envelope 100 simultaneously. This is done to save costs and further to improve the speed in which envelopes are produced. Furthermore, the process of cutting and manufacturing envelopes is improved if a die cutter cuts both parts simultaneously, rather than having to feed the envelope back into a die cutter assembly more than once.

Another object of the present invention is a method of sealing an alternative substrate envelope 100, comprising introducing an envelope 100 with an outer surface 1000 of a first material 1001, and inner surface 1200 of a second material 1201, wherein the envelope 100 has a removed segment 140 from the back 240 of the envelope patched with a third material 330/410; packing contents into the envelope 100 in the space 150; folding a top flap 110 of the envelope 100 down, wherein the top flap 110 has the second material on its inner surface 1200; and sealing the envelope 100, wherein the second material 1201 bonds with the third material 330/410 patched on the back 240 of envelope 100, wherein the third material 330/410 is more adhereable than the first material 1001.

The method further comprises having automated devices pack contents such as a letter into envelope 100. These automated devices include, but are not limited to, robots, hydraulic members, and other such assemblies whereby the envelopes are packed without human interaction. This limits the human factor in packing envelopes, whereby time is saved as well as cost of human labor.

The method further comprises the step wherein the automated devices fold and seal envelope 100. This similarly cuts down on human hours, which reduces cost.

In a preferred embodiment, this method pertains to having an envelope 100 where the first material 1001 is made of a non-adhereable material or material that has very low adhereability.

While the invention has been specifically described in connection with certain specific embodiments thereof, it is to be understood that this is by way of illustration and not of limitation and that various changes and modifications in form and details can be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. An envelope comprising:
an outer surface made of a first material, and an inner surface made of a second material;
a back panel, wherein said back panel has a segment cut out from said back panel, and wherein said back panel is patched with a third material;
a flap, wherein said flap folds to bond with said third material of said back panel, wherein said third material is more adhereable than said first material of said outer surface.

2. The envelope of claim 1, further comprising an adhesive strip on said flap.

3. The envelope of claim 2, wherein said adhesive strip bonds with said third material to seal the envelope.

4. The envelope of claim 1, further comprising an adhesive strip on said third material on said back panel.

5. The envelope of claim 4, wherein said adhesive strip bonds with said flap to seal the envelope.

6. The envelope of claim 1, wherein said flap contains a sealing and non-sealing section.

7. The envelope of claim 6, wherein said sealing section of said flap corresponds with said third material of said back panel when the envelope is sealed.

8. The envelope of claim 1, wherein the envelope does not require the use of any hot melt adhesives or peel and seal type latex adhesives.

9. The envelope of claim 1, wherein the third material is more adhereable than the first material by a factor of two or greater.

10. The envelope of claim 1, wherein said second material is the same as said third material.

11. The envelope of claim 1, wherein said first material on said outer surface is non-adhereable.

12. The envelope of claim 1, further comprising a window.

13. The envelope of claim 1, further comprising:
a right flap, a left flap, and a bottom flap,
wherein said right flap and said left flap bond to said bottom flap to form said back panel of the envelope.

14. A method of manufacturing an envelope comprising the steps of:
introducing an envelope with an outer surface made of a first material;
removing a segment from the back of said envelope;
patching said segment with a second material, wherein said second material is more adhereable than said first material; and
aligning said second material with a flap to allow for the sealing of the envelope.

15. The method of claim 14, further comprising applying an adhesive strip on said flap.

16. The method of claim 14, further comprising applying an adhesive strip on said second material of said back of said envelope.

17. The method of claim 14, wherein said outer surface is made of a non-adhereable material.

18. The method of claim 14, further comprising cutting out a window on the front of said envelope.

19. The method of claim 18, further comprising patching said window with a transparent material.

20. The method of claim 19, wherein said window and said back of the envelope are cut simultaneously.

21. The method of claim 20, wherein said window and said back of the envelope are cut via a die.

22. A method of sealing an alternative substrate envelope, comprising
introducing an envelope with an outer surface of a first material, and inner surface of a second material, wherein the envelope has a removed segment from the back of the envelope patched with a third material;
packing contents into the envelope;
folding a top flap of said envelope down, wherein said top flap has said second material on its inner surface; and
sealing the envelope, wherein said second material bonds with said third material patched on the back of the envelope, wherein said third material is more adhereable than said first material.

23. The method of claim 22, wherein automated devices pack said contents into the envelope.

24. The method of claim 22, wherein automated devices conduct the step of folding and sealing said envelope.

25. The method of claim 22, wherein said first material is non-adhereable.
